(19) United States
(12) Patent Application Publication
(10) Pub. No.: US 2007/0184975 A1
(43) Pub. Date: Aug. 9, 2007

(54) Photocatalyst including oxide-based nanomaterial

(75) Inventors: Gyu-chul Yi, Gyungbuk (KR); Sung-Jin An, Gyungbuk (KR)

Correspondence Address: INTELLECTUAL PROPERTY LAW GROUP LLP, 12 SOUTH FIRST STREET, SUITE 1205, SAN JOSE, CA, 95113, US

(73) Assignee: POSTECH FOUNDATION, Kyungbuk-do (KR)

(21) Appl. No.: 10/598,631

(22) PCT Filed: Mar. 11, 2005
(86) PCT No.: PCT/KR05/00698

§ 371 Date: Sep. 6, 2006

(30) Foreign Application Priority Data
Mar. 11, 2004 (KR) 10-2004-0016412

(51) Int. Cl. B01J 27/24

(52) U.S. Cl. 502/343; 502/350; 502/232; 502/240; 502/200; 502/208

(57) ABSTRACT

Disclosed is a photocatalyst having a matrix which comprises a substrate and oxide-based nanomaterial formed on the substrate. The photocatalyst has a ratio of area to volume that is higher than a conventional photocatalyst having the same components, and also has a nano-sized photocatalytic layer. Thereby, it has excellent photolytic properties.

### TECHNICAL FIELD

The present invention relates, in general, to a photocatalyst and, more particularly, to a photocatalyst which includes oxide-based nanomaterial formed on a substrate.

### BACKGROUND ART

A photocatalyst is material which is capable of absorbing light, particularly ultraviolet light, to generate a substance having strong oxidizing or reducing power and which treats a great quantity of chemicals or non-degradable contaminants using light instead of using energy in an environmentally friendly manner to prevent environmental pollution.

If the photocatalyst is exposed to light, electrons (e−) and holes (h+) are generated. The electrons and the holes come into contact with oxygen and water to generate superoxide anions (•O₂−) having strong oxidizing power and hydroxy radicals (•OH), and they can oxidize and decompose organic contaminants or various kinds of bacteria.

A typical photocatalyst is a thin film type or a powder type. The thin film type photocatalyst is a photocatalyst in which a photocatalytic layer containing a semiconductor component is applied on a surface of a substrate, and is disclosed in, for example, Korean Patent Laid-Open Publication No. 2002-0011511. The powder-type photocatalyst is a photocatalyst in which a semiconductor component is a spherical type or an oval type, and is exemplified by a spherical titania photocatalyst in Korean Patent Laid-Open Publication No. 2003-0096171.

However, in the thin film type or powder type photocatalyst, the area capable of absorbing light may be limited by the surface area of a thin film type photocatalytic surface layer or a spherical type photocatalytic surface layer. In addition, when the powder type photocatalyst is used in some specific media, difficulties, such as the powder of the photocatalyst floating in the media, may arise.

Accordingly, there still remains a need to develop a photocatalyst having a novel structure, which is capable of providing a wide surface area, instead of using the conventional thin film-type or powder-type photocatalyst, thereby providing a photocatalyst having high performance.

### SUMMARY OF THE INVENTION

Accordingly, the present invention has been made keeping in mind the above problems occurring in the prior art, and an object of the present invention is to provide a photocatalyst which includes oxide-based nanomaterial having a maximized ratio of surface area to volume using nanotechnology.

Another object of the present invention is to provide a photocatalyst including oxide-based nanomaterial, which has a nano-sized photocatalytic layer, thus having excellent photolytic properties.

In order to accomplish the above objects, the present invention provides a photocatalyst which comprises a matrix including a substrate and oxide-based nanomaterial formed on the substrate.

In the present invention, the substrate is selected from the group consisting of a silicon substrate, a glass substrate, a quartz substrate, a Pyrex substrate, a sapphire substrate, and a plastic substrate.

Additionally, in the present invention, the oxide-based nanomaterial has the shape of a nanoneedle, nanorod, or nanotube.

Furthermore, in the present invention, the oxide-based nanomaterial has a multi-wall structure.

As well, in the present invention, the oxide-based nanomaterial having the multi-wall structure has a coaxial doublewall structure including ZnO and TiO₂ as a main component.

Further, in the present invention, the oxide-based nanomaterial has a heterojunction structure of metal/oxide semiconductor formed by depositing metal on an oxide semiconductor nanorod.

In addition, in the present invention, the metal is deposited on the oxide semiconductor nanorod through a sputtering process or a thermal or electron beam evaporation process.

As well, in the present invention, an oxide semiconductor comprises ZnO as a main component, and one or more metals, which are selected from the group consisting of silicide-based metals, including Ni, Pt, Pd, Au, Ag, W, Ti, Al, In, Cu, PtSi, and NiSi, are used.

Additionally, in the present invention, the oxide-based nanomaterial is vertically oriented on the substrate.

Furthermore, in the present invention, the oxide-based nanomaterial is formed on the substrate through any one of a metal-organic chemical vapor deposition process, a sputtering process, a thermal or electron beam evaporation process, a pulse laser deposition process, a vapor-phase transport process, and a chemical synthesis process.

Furthermore, in the present invention, the oxide-based nanomaterial has a diameter of 5-200 nm and a length of 0.5-100 □.

Furthermore, in the present invention, the oxide-based nanomaterial comprises ZnO as a main component. Additionally, the oxide-based nanomaterial may comprise one or more element selected from the group consisting of Mg, Cd, Ti, Li, Cu, Al, Ni, Y, Ag, Mn, V, Fe, La, Ta, Nb, Ga, In, S, Se, P, As, Co, Cr, B, N, Sb, and H as impurities, in addition to ZnO as the main component.

Furthermore, in the present invention, the oxide-based nanomaterial comprises TiO₂ as a main component. Additionally, the oxide-based nanomaterial may comprise one or more elements selected from the group consisting of Mg, Cd, Zn, Li, Cu, Al, Ni, Y, Ag, Mn, V, Fe, La, Ta, Nb, Ga, In, S, Se, P, As, Co, Cr, B, N, Sb, and H as impurities, in addition to TiO₂ as the main component.

Furthermore, in the present invention, the oxide-based nanomaterial is coated with any one compound selected from the group consisting of MgO, CdO, GaN, AlN, InN, GaAs, GaP, InP, and a compound thereof.

The photocatalyst of the present invention is advantageous in that, since the ratio of surface area to volume of a photocatalytic layer is very high and the photocatalyst has the nano-sized photocatalytic layer in comparison with a conventional powder-type or thin film-type photocatalyst, excellent photolytic properties are assured and it is possible to produce it at low cost using various substrates.

### BRIEF DESCRIPTION OF THE DRAWINGS

The above and other objects, features and other advantages of the present invention will be more clearly understood from the following detailed description taken in conjunction with the accompanying drawings, in which:

FIGS. 1a and 1b illustrate a structure of a photocatalyst including oxide-based nanoneedles according to the present invention and a scanning electron microscope (SEM) picture of the photocatalyst, respectively;

FIGS. 2a and 2b illustrate a structure of a photocatalyst including oxide-based nanorods according to the present invention and a SEM picture of the photocatalyst, respectively;

FIGS. 3a to 3c illustrate a structure of a photocatalyst including oxide-based nanotubes according to the present invention and a transmission electron microscope (TEM) picture of the photocatalyst;

FIG. 4 illustrates a photocatalyst including oxide-based nanorods having a multi-wall structure, according to the present invention;

FIG. 5 illustrates a photocatalyst including oxide-based nanorods having a heterojunction structure, according to the present invention;

FIG. 6 is a SEM picture of the oxide-based photocatalyst of the present invention, which illustrates that nanomaterials are not vertically oriented;

FIGS. 7a and 7b illustrate a structure of a photocatalyst including oxide-based GaN-coated nanoneedles according to the present invention and a TEM picture of the photocatalyst, respectively;

FIGS. 8a and 8b illustrate the photolysis results of a photocatalyst including ZnO nanoneedles and a ZnO thin film using an Orange II solution according to the present invention, which are shown in the form of an absorption spectrum and an amount of dye decomposed in relation to irradiation time;

FIGS. 9a and 9b illustrate the photolysis results of a photocatalyst including ZnO nanorods using a methylene blue solution according to the present invention, which are shown in the form of an absorption spectrum and an amount of dye decomposed in relation to irradiation time;

FIGS. 10a to 10d are SEM pictures which show variation in a structure of the photocatalyst in the course of producing the photocatalyst including oxide-based nanorods having a multi-wall structure, according to the present invention;

FIGS. 11a and 11b are SEM pictures of the photocatalyst including the oxide-based nanotubes, according to the present invention; and

FIGS. 12a to 12c are SEM and TEM pictures of the photocatalyst including the oxide-based nanorods having the heterojunction structure, according to the present invention.

### DETAILED DESCRIPTION OF SPECIFIC EMBODIMENTS

Hereinafter, a detailed description will be given of the present invention. In the description of the present invention, if it is considered that a detailed description of related prior arts or constitutions may unnecessarily obscure the gist of the present invention, the detailed description will be omitted. Furthermore, the terminology as described later is defined in consideration of functions of the present invention, and depends on the purpose of a user or a worker, or a precedent. Therefore, the definition must be understood in the context of the specification.

For convenience of understanding, additionally, zinc oxide (ZnO) and titanium oxide (TiO₂) are mainly described as representative examples of oxide-based nanomaterial of the present invention in the specification, but it is obvious that the oxide-base nanomaterial of the present invention is not limited to them.

A photocatalyst of the present invention comprises a matrix which includes a substrate and oxide-based nanomaterial formed on the substrate.

The substrate is material which does not usually react with the oxide-based nanomaterial to be formed thereon, and its non-limiting examples include a silicon substrate, a glass substrate, a quartz substrate, a Pyrex substrate, a sapphire substrate, or a plastic substrate.

The oxide-based nanomaterial having the shape of nanoneedle, nanorod, or nanotube is formed on the substrate as described above, and the nanomaterial having the shape of nanoneedle, nanorod, or nanotube may have a multi-wall structure.

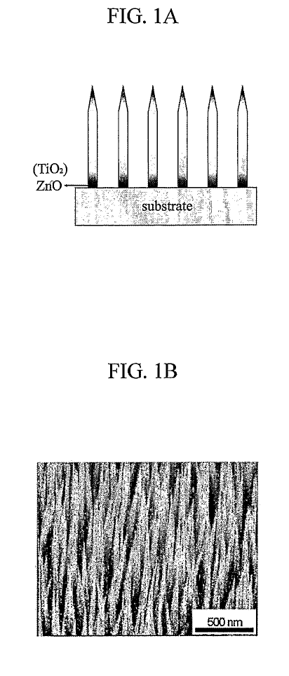

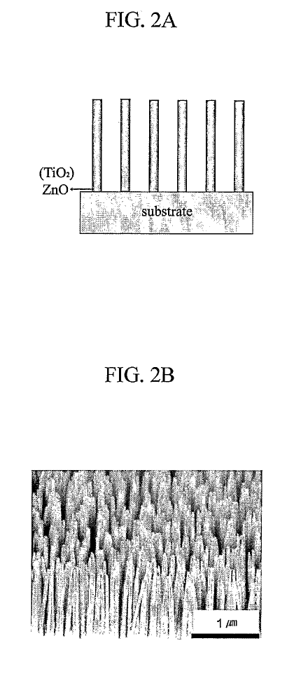

Structures of the photocatalysts, which comprise the substrates and the oxide-based nanomaterials having the shape of nanoneedle and nanorod vertically oriented on the substrates, are illustrated in FIGS. 1a and 2a, respectively. SEM pictures of them are shown in FIGS. 1b and 2b.

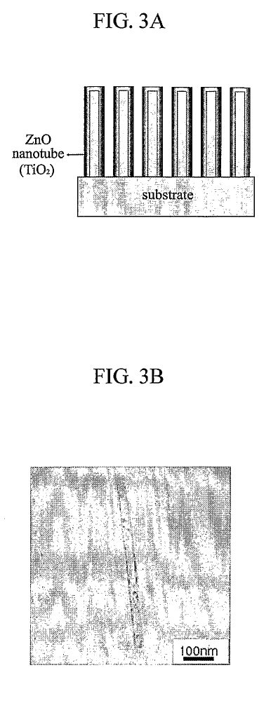

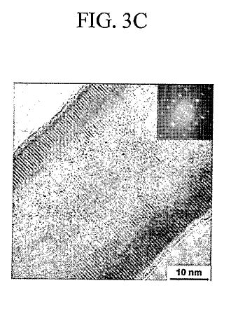

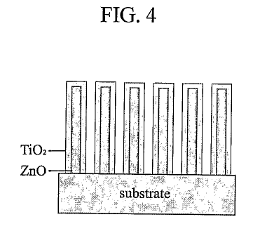

Furthermore, a structure of a photocatalyst which includes a substrate and oxide-based nanomaterial having the shape of vertically oriented nanotubes on the substrate is illustrated in FIG. 3a, and TEM pictures of the catalyst are shown in FIGS. 3b and 3c. The nanomaterial having the shape of nanotubes shown in FIG. 3a has an appearance similar to the nanomaterial having the shape of nanorods of FIG. 2a, but has a hollow external wall. The external wall may have a singular wall, double wall, or multi-wall structure.

FIG. 4 illustrates a photocatalyst including oxide-based nanorods having a multi-wall structure according to the present invention, in which the oxide-based nanomaterial has a ZnO nanorod as an internal part and a TiO₂ nanorod as an external part. Needless to say, the present invention is not limited to this structure.

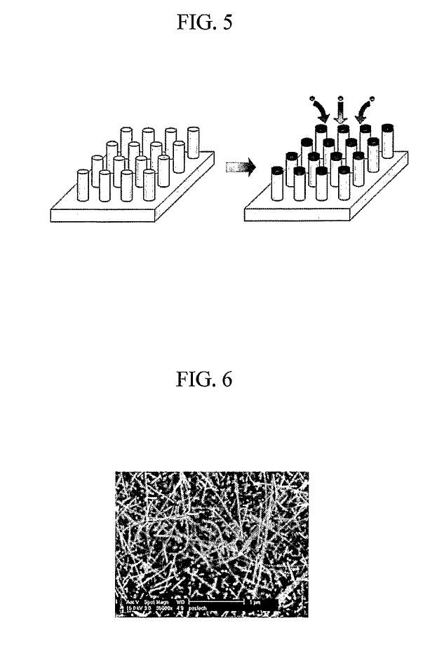

FIG. 5 illustrates a photocatalyst including oxide-based nanorods having a heterojunction structure according to the present invention, which shows the production of the nanorods having the heterojunction structure of metal/oxide semiconductor.

Meanwhile, FIGS. 1a to 5 as described above illustrates only vertical orientation of oxide-based nanomaterial on the substrate, but, as shown in a SEM picture of FIG. 6, the photocatalyst of the present invention may include oxide-based nanomaterial non-vertically orientated on the substrate.

Typically, the nanomaterial having the shape of nanoneedles, nanorods, or nanotubes according to the present invention may have a diameter of about 5-200 nm, a length of 0.5-100□, and a density of 10¹⁰/cm². Accordingly, a surface area of the nano-sized nanomaterial of the present invention may be a few hundred times as large as that (in other words, a surface area of a photocatalytic layer when material of a photocatalytic layer having the same component is produced in a thin film-type) of the substrate on which the nanomaterial is formed. The photocatalyst of the present invention includes the photocatalytic layer having a unique structure as described above, thus it includes the photocatalytic layer having the improved properties.

Furthermore, since the nanomaterial photocatalytic layer of the present invention is nanosize as well as has a large surface area as described above, it has better electron and hole forming ability than a photocatalytic layer having the same component that is not nanosize. As well known to those skilled in the art, chemical and physical properties of a solid crystalline structure have no relation to the size of a crystal, but, if the size of the solid crystal is a few nanometers, the size acts as a variable determining the chemical and physical properties, for example, a band gap, of the crystalline structure. Accordingly, it is considered that the nanomaterial of the present invention, which has a size of a few nanometers, effectively forms electrons and holes, thereby improving performance of the photocatalyst.

Furthermore, it is possible to cause electrons generated using light to crowd toward metal by using the above metal/oxide semiconductor heterojunction structure, thus it is possible to reduce the recombination speed of the electrons with the holes. Hence, the electrons and the holes are easily bonded to external oxygen or water, thus an increase in photolysis efficiency of external contaminants can be expected.

The nanomaterial of the present invention is formed on various substrates through a physical growth process, such as a chemical vapor deposition process including a metal-organic vapor deposition process, a sputtering process, a thermal or electron beam evaporation process, and a pulse laser deposition process, a vapor-phase transport process using a metal catalyst, such as gold, or a chemical synthesis process. Preferably, the growth may be conducted through a metal-organic chemical vapor deposition (MOCVD) process.

In the method of producing the photocatalyst of the present invention, oxide-based (herein, ZnO is exemplified) nanoneedles are formed on the substrate through the following procedure. Firstly, zinc-containing organometal and oxygen-containing gas or oxygen-containing organics are fed through separate lines into an organometallic vapor deposition reactor. Non-limiting examples of the zinc-containing organometal include dimethylzinc [Zn(CH₃)₂], diethylzinc [Zn(C₂H₅)₂], zinc acetate [Zn(OOCCH₃)₂□H₂O], zinc acetate anhydride [Zn(OOCCH₃)₂], or zinc acetyl acetonate [Zn(C₅H₇O₂)₂], and non-limiting examples of the oxygen-containing gas include O₂, O₃, NO₂, steam, or CO₂. Non-limiting examples of the oxygen-containing organics include C₄H₈O.

Subsequently, the above reactants are reacted at a pressure of 10⁻⁵-760 mmHg and a temperature of 200-900□ to deposit and grow ZnO nanoneedles on the substrate. The reaction pressure, temperature and flow rates of the reactants are controlled to adjust the diameter, length, and density of each nanoneedle to be formed on the substrate, thereby forming nanomaterial having the desired total surface area on the substrate.

Meanwhile, the nanorod having a heterojunction structure of the metal/oxide semiconductor is formed by depositing metal, such as Au, on the oxide—e.g. ZnO—semiconductor nanorod through a sputtering process or a thermal or e-beam evaporation process. In this case, since metal is selectively deposited on the tip of the nanorod, the metal/oxide semiconductor heterojunction structure having a smooth interface is easily formed. Various types of metals may be deposited on the tip of the oxide semiconductor nanorod, and, particularly, it is preferable to use one or more silicide-based metal, such as Ni, Pt, Pd, Au, Ag, W, Ti, Al, In, Cu, PtSi, or NiSi.

An acceleration voltage and an emission current of an electronic beam used to evaporate metal are 4-20 kV and 40-400 mA, respectively, and it is preferable that the pressure of the reactor be 10⁻⁵ mmHg or so during deposition of metal and the temperature of a matrix be maintained at room temperature.

The above metal insignificantly affects the diameter and the shape of the oxide semiconductor nanorod, and it is possible to adjust the thickness of the metal layer of the nanorod having the heterojunction structure, or the diameter and length of the nanorod, by controlling conditions such as a growth time.

To improve its electron and hole forming ability, the oxide-based nanomaterial of the photocatalyst according to the present invention, for example, ZnO nanomaterial, may further comprise one or more elements, which are selected from the group consisting of Mg, Cd, Ti, Li, Cu, Al, Ni, Y, Ag, Mn, V, Fe, La, Ta, Nb, Ga, In, S, Se, P, As, Co, Cr, B, N, Sb, and H, as impurities. In this case, if the concentration of the impurity is high, the nanomaterial may be called an alloy of the oxide semiconductor material. The nanomaterial of the present invention may contain the above element by feeding organometal containing the above element in conjunction with zinc-containing organometal into the organometallic vapor deposition reactor.

It is preferable that the nanomaterial contain Mg or Cd as impurities, and, for example, the TiO₂ nanomaterial can contain Zn instead of Ti as the impurity.

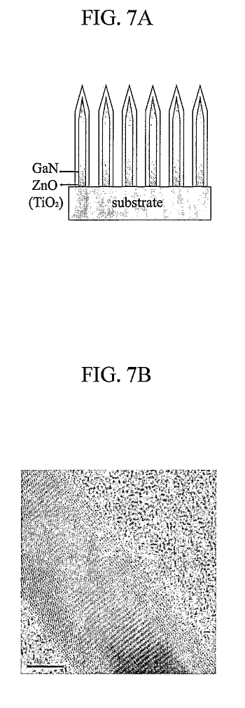

Meanwhile, the nanomaterial of the photocatalyst according to the present invention may be coated with any one compound selected from the group consisting of MgO, CdO, GaN, AlN, InN, GaAs, GaP, InP, or a compound thereof. FIG. 7a illustrates oxide-based nanoneedles which are vertically oriented on a substrate and which are coated with GaN, and FIG. 7b shows a TEM picture of the nanoneedles having the above structure. The coating layer of the material improves the electron and hole forming ability and forms a protective layer made of nanomaterial, thereby variously affecting the photocatalyst of the present invention.

A better understanding of the present invention may be obtained through the following examples which are set forth to illustrate, but are not to be construed as the limit of the present invention.

### EXAMPLE 1

### Production of a Photocatalyst Including ZnO Nanoneedles

A glass substrate was put in a metal-organic chemical vapor deposition (MOCVD) reactor, and dimethylzinc (Zn(CH₃)₂) and O₂ gas were fed through separate lines into the reactor at rates of 0.1-10 sccm and 10-100 sccm, respectively. Argon (Ar) was used as carrier gas.

An inside of the reactor was maintained at a pressure of 0.2 torr and a temperature of 500□ for 1 hour to chemically react dimethylzinc and oxygen on the glass substrate, thereby growing and depositing the ZnO nanoneedles.

As a result, each of the ZnO nanoneedles vertically oriented on the glass substrate had a diameter of 60 nm, a length of 1□, and a density of 10¹⁰/cm².

### EVALUATION EXAMPLE 1

The performance of a photocatalyst including ZnO nanoneedles produced according to example 1 (see FIGS. 1a and 1b) was evaluated using variation in the color of a dye.

In the evaluation, an “Orange II” solution was used as the dye, and a ZnO thin film having the same components as the ZnO nanoneedles was used as a comparative example. The above ZnO thin film was created by growing it for 2 hours without deposition of a buffer layer as a growth factor for the ZnO nanoneedles produced according to the above example.

Firstly, four test tubes each containing 5 ml of Orange II solution were prepared. Test conditions for each test tube were set as described in the following Table 1, and photocatalysis tests A to D were conducted using the Orange II solution.

TABLE 1

| | | Irradiation time |
|---|---|---|
| Photolysis test | Used photocatalyst | (photolysis time of dye) |
| A(basis value) | — | 0 hour |
| B | ZnO thin film | 5 hours |
| C | ZnO thin film | 15 hours |
| D | ZnO nanoneedle | 5 hours |

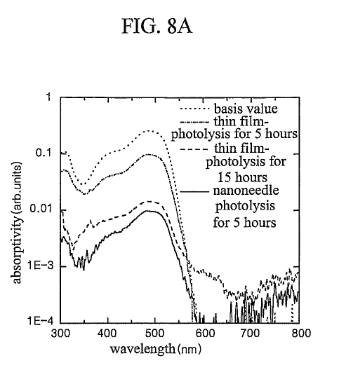

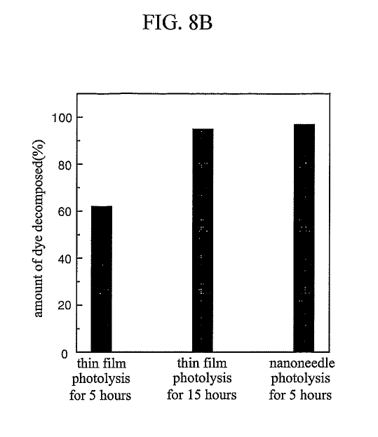

The results of the photocatalysis tests A to D are shown in a graph and a histogram of FIGS. 8a and 8b. FIG. 8a is the absorption spectrum graph which shows the results of the photocatalysis tests A to D, and FIG. 8b is the histogram relating to the amount of dye decomposed.

From FIG. 8a, it can be seen that absorptivity of the test D, in which the Orange II solution is photolyzed using the photocatalyst having the ZnO nanoneedles of the present invention for 5 hours, is lower than absorptivity of the test B, in which the photolysis is conducted using a ZnO thin film as the photocatalyst with irradiation for 5 hours, and than absorptivity of the test C, in which the photolysis is conducted using the ZnO thin film as the photocatalyst with irradiation for no less than 15 hours.

Furthermore, referring to FIG. 8b, it can be seen that the amount of dye decomposed using the photocatalyst including the ZnO nanoneedles according to the present invention in the test D is 97% of the amount of dye before the test is conducted, but the amount of dye photolyzed using the ZnO thin film as the photocatalyst for 5 hours is merely 62% in the test B.

The amount of dye decomposed by the photocatalyst of the present invention is almost similar to the amount of dye decomposed using the ZnO thin film as the photocatalyst for a lengthy irradiation time of 15 hours in the test C.

### EVALUATION EXAMPLE 2

The performance of a ZnO nanorod photocatalyst (see FIGS. 2a and 2b), produced through a procedure similar to example 1, was evaluated using variation in the color of another dye. In the evaluation, the dye in which methylene blue was diluted with water was used as a solution for photolysis.

After the solution for photolysis was charged in a vessel and then left for a predetermined time, the solution was sampled. The sampled solution was diluted again and put in a UV VIS spectrometer to measure absorptivity. Since methylene blue most favorably absorbs light corresponding to 660 nm, absorptivity of light corresponding to 660 nm is reduced if the amount of methylene blue is reduced. Additionally, the amount of methylene blue in the solution has a linear relationship to absorptivity. Therefore, the amount of methylene blue can be calculated by measuring absorptivity. Through the calculation, it is possible to evaluate photolytic efficiency of the ZnO nanorod.

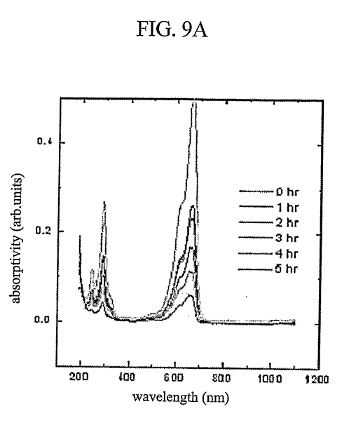

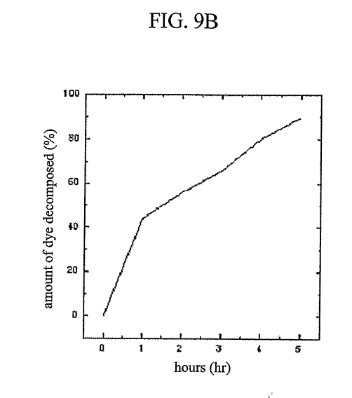

The photolysis test results are shown in graphs of FIGS. 9a and 9b. FIG. 9a is an absorption spectrum graph which illustrates the photolysis test results, and FIG. 9b is a graph which shows the amount of dye decomposed.

### EXAMPLE 2

### Production of TiO₂ Nanorods

A metal-organic chemical vapor deposition (MOCVD) device was used, titanium isopropoxide (TIP, Ti(OC₃H₇ⁱ)₄) and O₂ were used as reactants, and argon (Ar) was used as a carrier gas.

TIP and O₂ were fed through separate lines into a reactor. The pressure and temperature in the reactor were maintained at 0-100 mmHg and 300-700□, respectively. Flow rates of the reactants were controlled to be 40 sccm for argon, 20-40 sccm for TIP, and 20-40 sccm for O₂, and growth was conducted for about 1 hour.

### EXAMPLE 3

### Production of TiO₂/ZnO Coaxial Doublewall Nanorods Using MOCVD

After ZnO nanorods were produced through a procedure similar to example 1 (see a SEM picture of FIG. 8a), the ZnO nanorods thus produced were put in a metal-organic chemical vapor deposition (MOCVD) device, and TIP and O₂ were fed through separate lines into a reactor.

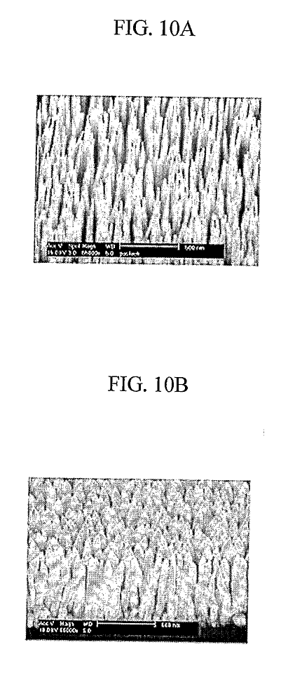

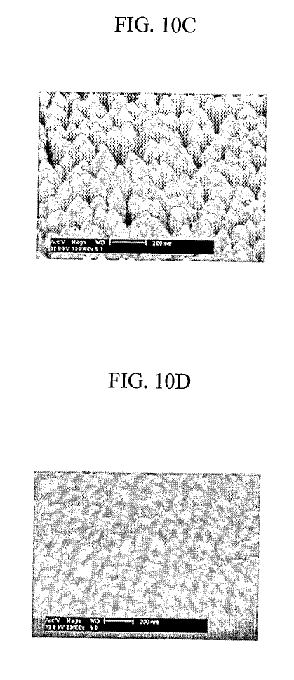

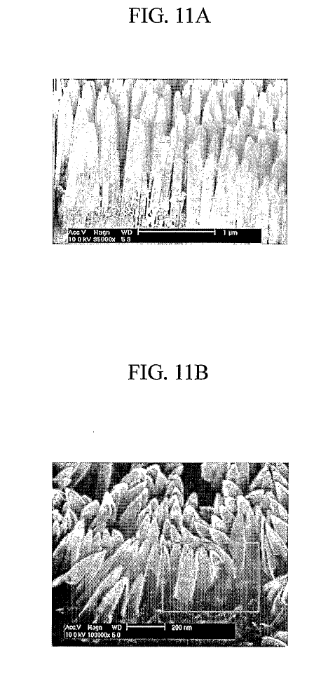

The pressure and temperature in the reactor were maintained at 0-100 mmHg and 300-700□, respectively. Flow rates of the reactants were controlled to be 40 sccm for argon, 20-40 sccm for TIP, and 20-40 sccm for O₂, and the TiO₂/ZnO coaxial doublewall nanorods were grown for about 1-10 min. SEM pictures of the resulting products are shown in FIGS. 10b to 10d. From the pictures, it can be seen that it is possible to adjust the diameters of the TiO₂/ZnO coaxial doublewall nanorods by controlling the growth time.

### EXAMPLE 4

### Production of TiO₂/ZnO Coaxial Doublewall Nanorods Using PLD

ZnO nanorods grown through a procedure similar to example 1 were put in a pulse laser deposition (PLD) device, a TiO₂ target was ablated using a pulse laser (Laser ablation), and O₂ gas was fed through an additional line into the reactor at a rate of 0.1-100 sccm.

The pressure and temperature were maintained at 10⁻⁹-100 mmHg and 20-800□, respectively, and reaction precursors were chemically reacted in the reactor for 5 min or more to deposit TiO₂ on the ZnO nanorods, thereby producing the TiO₂/ZnO coaxial doublewall nanorods.

### EXAMPLE 5

### Production of TiO₂ Nanotubes Using Dry Etching

TiO₂/ZnO coaxial doublewall nanorods were produced through the same procedure as example 3 or 4, the TiO₂/ZnO coaxial doublewall nanorods were put in a furnace or a metal-organic chemical vapor deposition (MOCVD) device in a hydrogen (H₂) or ammonia (NH₃) atmosphere, and H₂ or NH₃ was fed through separate lines into the reactor.

The pressure and temperature in the reactor were maintained at 100 mmHg and 600-700□, respectively, and the ZnO nanorods were removed for 20 min, thereby producing the TiO₂ nanotubes. With respect to this, the removal time was in proportion to the size of the ZnO nanorod.

### EXAMPLE 6

### Production of TiO₂ Nanotubes Using Wet Etching

TiO₂/ZnO coaxial doublewall nanorods were produced through the same procedure as example 3 or 4, the TiO₂/ZnO coaxial doublewall nanorods were immersed in a hydrogen chloride solution (pH 4-6) which was produced by mixing hydrogen chloride (HCl) with water (H₂O), and ZnO was removed for 1-30 min, thereby creating the TiO₂ nanotubes. The reaction temperature was in the range from room temperature to 80□.

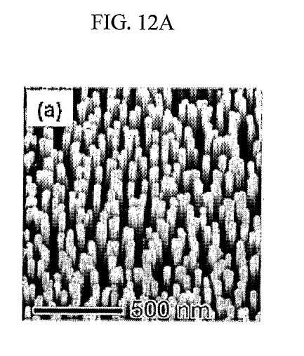

Meanwhile, SEM pictures of oxide-based nanotubes produced through examples 5 and 6 are illustrated in FIGS. 11a and 11b. FIG. 11a shows the removal of half of the ZnO, and FIG. 11b shows the complete removal of ZnO.

### EXAMPLE 7

### Production of Au/ZnO Nanorods (Heterojunction Structure) Using Electron Beam Evaporation

After ZnO nanorods were produced through the similar procedure to example 1 (see FIGS. 2a and 2b), gold (Au) was deposited on the ZnO nanorods through an electron beam evaporation process.

An acceleration voltage and an emission current of an electronic beam which were used to evaporate Au were 4-20 kV and 40-400 mA, respectively, a pressure of the reactor was 10⁻⁵ mmHg or so during the deposition of Au, and the temperature of a matrix was maintained at room temperature.

The array of the ZnO nanorods before and after Au was deposited was observed using an electron microscope, and it was confirmed that Au was selectively and nicely deposited on the tips of the ZnO nanorods and the diameter or the shape of the ZnO nanorods was insignificantly changed. Furthermore, it was confirmed that it was possible to adjust the thickness of the Au layer and the diameter and length of ZnO in Au/ZnO nanorods having a heterojunction structure by controlling the growth time of the ZnO nanorods and the deposition time of Au.

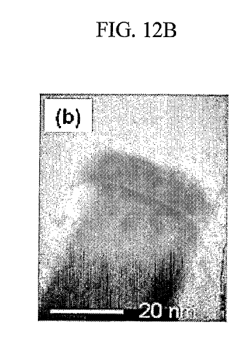

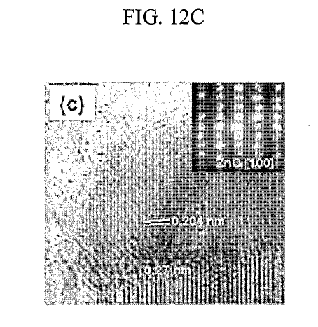

Meanwhile, SEM pictures of Au/ZnO nanorods having the heterojunction structure produced according to the present example are shown in FIG. 12a, and TEM pictures of them are shown in FIGS. 12b and 12c.

### INDUSTRIAL APPLICABILITY

A photocatalyst including oxide-based nanomaterial according to the present invention is advantageous in that, since the ratio of surface area to volume is significantly high in comparison with a conventional photocatalyst, efficiency of the photocatalyst is largely improved.

Additionally, the photocatalyst including oxide-based nanomaterial according to the present invention is advantageous in that, since it is possible to produce the photocatalyst through a simple process in which oxide-based nanomaterial is grown on various low-priced substrates having a large area using a metal-organic vapor deposition process, the production cost is low. As well, since an additional metal catalyst is not used, contamination by impurities due to a metal catalyst is prevented during the production process.

1. A photocatalyst including a matrix, the matrix comprising:
a substrate; and
oxide-based nanomaterial formed on the substrate.

2. The photocatalyst as set forth in claim 1, wherein the substrate is selected from the group consisting of a silicon substrate, a glass substrate, a quartz substrate, a Pyrex substrate, a sapphire substrate, and a plastic substrate.

3. The photocatalyst as set forth in claim 1, wherein the oxide-based nanomaterial has a shape of a nanoneedle, nanorod, or nanotube.

4. The photocatalyst as set forth in claim 3, wherein the oxide-based nanomaterial has a multi-wall structure.

5. The photocatalyst as set forth in claim 4, wherein the oxide-based nanomaterial having the multi-wall structure has a coaxial doublewall structure including ZnO and TiO₂ as main components.

6. The photocatalyst as set forth in claim 1, wherein the oxide-based nanomaterial has a heterojunction structure of metal/oxide semiconductor formed by depositing metal on an oxide semiconductor nanorod.

7. The photocatalyst as set forth in claim 6, wherein the metal is deposited on the oxide semiconductor nanorod through a sputtering process or a thermal or electron beam evaporation process.

8. The photocatalyst as set forth in claim 6, wherein an oxide semiconductor comprises ZnO as a main component, and one or more metals, which are selected from the group consisting of silicide-based metals, including Ni, Pt, Pd, Au, Ag, W, Ti, Al, In, Cu, PtSi, and NiSi, is used.

9. The photocatalyst as set forth in claim 1, wherein the oxide-based nanomaterial is vertically oriented on the substrate.

10. The photocatalyst as set forth in claim 1, wherein the oxide-based nanomaterial is formed on the substrate through any one of a metal-organic chemical vapor deposition process, a sputtering process, a thermal or electron beam evaporation process, a pulse laser deposition process, a vapor-phase transport process, and a chemical synthesis process.

11. The photocatalyst as set forth in claim 1, wherein the oxide-based nanomaterial has a diameter from 5 to 200 nm and a length from 0.5 to 100 μm.

12. The photocatalyst as set forth in claim 1, wherein the oxide-based nanomaterial comprises ZnO as a main component.

13. The photocatalyst as set forth in claim 12, wherein the oxide-based nanomaterial comprises one or more elements selected from the group consisting of Mg, Cd, Ti, Li, Cu, Al, Ni, Y, Ag, Mn, V, Fe, La, Ta, Nb, Ga, In, S, Se, P, As, Co, Cr, B, N, Sb, and H, as impurities, in addition to ZnO as the main component.

14. The photocatalyst as set forth in claim 12, wherein the oxide-based nanomaterial is coated with any one compound selected from the group consisting of MgO, CdO, GaN, AlN, InN, GaAs, GaP, InP, and compounds thereof.

15. The photocatalyst as set forth in claim 1, wherein the oxide-based nanomaterial comprises TiO₂ as a main component.

16. The photocatalyst as set forth in claim 15, wherein the oxide-based nanomaterial comprises one or more elements selected from the group consisting of Mg, Cd, Zn, Li, Cu, Al, Ni, Y, Ag, Mn, V, Fe, La, Ta, Nb, Ga, In, S, Se, P, As, Co, Cr, B, N, Sb, and H, as impurities, in addition to TiO₂ as the main component.

17. The photocatalyst as set forth in claim 15, wherein the oxide-based nanomaterial is coated with any one compound selected from the group consisting of MgO, CdO, GaN, AlN, InN, GaAs, GaP, InP, and compounds thereof.
